(19) United States
(12) Patent Application Publication
(10) Pub. No.: US 2006/0257571 A1
(43) Pub. Date: Nov. 16, 2006

(54) Method and apparatus for surface coating repair and rust prevention

(76) Inventor: Yong-Jun Tan, Singapore (SG)

Correspondence Address: School of Chemistry Monash University;c/o Alan Bond Electrochemistry Group, Clayton Campus, Melbourne, VIC 3800, AU

(21) Appl. No.: 11/129,533

(22) Filed: May 16, 2005

(51) Int. Cl. B05D 3/00

(52) U.S. Cl. 427/299; 427/140; 118/200

(57) ABSTRACT

The present invention discloses a surface coating repair method and associated apparatus that reduce the level of skill required to perform a quality repair of blemishes, graffiti, coating damages and corrosion on the surface of automobiles, boats, aircrafts, machineries, motorbikes, bicycles, washing machines, refrigerators, light fixtures, fence posts, doors, furniture, and other industrial, household appliances and building structures. This is achieved by providing a method of effectively preparing and protecting a damaged surface using abrasive wool sucked with a cleaning and protective liquid, by providing a method of mixing touch-up paint that matches the color of a damaged organic or metallic coating, and by providing an effective and inexpensive surface maintenance and coating repair kit that includes apparatus and materials for performing surface preparation, paint mixing and paint application.

### CROSS-REFERENCE TO RELATED APPLICATIONS

Not Applicable

### STATEMENT REGARDING FEDERALLY SPONSORED RESEARCH OR DEVELOPMENT

Not Applicable

REFERENCE TO A “MICROFICHE APPENDIX”

Not Applicable

### BACKGROUND OF THE INVENTION

1. Field of the Invention

The present invention relates principally to the repair and protection of material surface and its coatings. More specifically, it relates to methods and apparatus that reduce the level of skill required to perform quality repair of blemishes, graffiti, damages and corrosion on the surfaces of automobiles, boats, aircrafts, machineries, motorbikes, bicycles, washing machines, refrigerators, furniture, toys, light fixtures, fence posts, doors, walls, and other industrial and household appliances and building structures.

2. Description of the Related Art

Localized surface damages are frequently the breeding ground of various forms of material failures such as localized corrosion of metals, degradation of plastics and blistering of organic coatings. It is thus important to promptly repair and protect a damaged surface using protective coatings and rustproofing materials. Surface cosmetic repair is sometimes also required in order to cover graffiti or minor damages on the surfaces of furniture and building walls. Unfortunately surface and coating repair in professional workshops is often slow and expensive, and thus people often wish to perform surface and coating repair job themselves. However for non-professional personnel to effectively repair a damaged surface or a broken coating, they have to overcome the following three difficulties.

The first difficulty is to perform effective surface preparation prior to painting. It is well know that surface preparation to remove rust, tar, wax, silicone, moisture, salt from substrate surface is a critical first step in any surface and coating repair job. Surface preparation is the key to good coating adhesion and has paramount importance in corrosion prevention by organic coatings, see W. Funke ‘The role of adhesion in corrosion protection by organic coatings’, JOCCA, Vol. 68, No. 9, 1985, pp 229-232. Unfortunately surface preparation is often the most difficult and neglected aspect in surface and coating repair. Most non-professional personnel have no access to specialized surface preparation equipment such as abrasive blasting equipment. They often have to use simple surface preparation tools such as a blade-like tool as described in U.S. Pat. No. 4,522,523, or a fiberglass bristled brush as described in U.S. Pat. No. 5,730,644, for rust removal and surface cleaning. Unfortunately surface preparation based on these simple scraping, sanding, brushing tools are often labor intensive and are often inadequate in removing all soluble contaminants, oil and grease from the substrate surface. Tannic and phosphatic acids based rust converters are often used in the preparation of steel surface since they are believed to be capable of converting rust to unharmful compounds. However the use of these acid-based chemical rust converters remains controversial, in fact in some cases they were found to be even harmful to the coating performance, see L. M. Ocampo, I. C. P. Margarit, 0. R. Mattos, S. I. Córdoba-de-Torresi and F. L. Fragata, ‘Performance of rust converter based in phosphoric and tannic acids’, Corrosion Science, Vol. 46, No. 6, 2004, pp 1515-1525. Other alternative methods of dealing with contaminated surfaces such as the use of water-borne paint and surface tolerant coatings also have limitations. Water-borne paint takes too long to dry and is thus inconvenient for coating repair applications. Surface tolerant coatings often contain environmentally harmful pigments such as red lead. There is thus a need to develop a new method for non-professional personnel to easily yet effectively prepare and protect materials surfaces.

The second difficulty is for non-professional personnel to obtain or mix a touch-up paint that matches the color of a damaged and aged surface. Finding suitable colored touch-up paints in paint stores is often impossible since it is impractical for a paint store to stock the hundreds of colors of commonly used touch-up paints. Mixing a small amount of touch-up paints in a conventional way is cost prohibitive since color matching and mixing usually require special equipment such as a color analyzer, a densitometer, a colorimeter, a reflecting or transmitting spectrophotometer. Paint manufacturers have never introduced an inexpensive yet effective method of matching and mixing color touch-up paints. In most cases non-professional personnel uses only a clear touch-up paint to seal off a damaged coating in order to prevent rust, which is unacceptable if a cosmetic repair is desired. U.S. Pat. No. 6,502,049 disclosed a method for a user to perform color matching and paint mixing using a color matching device, a base paint, pigment dispersions for rough color matching, thinned pigment dispersions for fine color matching and a data base indicating mixing amounts of them. This method is still too complex for non-professional personnel to mix small amount of colored touch-up paint since it needs a costly color matching device and skilled worker to precisely measure a small amount of base color paints for mixing. There is thus a need to develop a new method for non-professional personnel to easily yet effectively perform color matching and touch-up paint mixing.

The third difficulty is for non-professional personnel to obtain inexpensive yet effective apparatus for surface repair and protection jobs. It is very troublesome for them to find items such as surface preparation tools, sandpapers, sanding blocks, transparent and colored paints, volume measuring tools, paint mixing tools and paint applicators. Conventional surface and coating repair tools such as small spray equipment has the drawbacks of high cost, difficulty of use, the need for mixing large quantity of paint, and the requirement of masking surrounding areas. Some touch-up paint bottles have built-in brushes attached to the bottle cap, but the brushes are usually too large for the repair of most paint damages. There is thus a need of introducing an inexpensive, effective and convenient coating repair and surface maintenance kit for non-professional personnel.

### BRIEF SUMMARY OF THE INVENTION

It is an object of the present invention to provide a coating repair method and associated apparatus for non-professional personnel to perform quality repair of coating and surface blemish, graffiti, damage and corrosion on industrial or household appliances and building structures.

It is a further object of the present invention to provide a method of effectively preparing and protecting a locally damaged surface. Abrasive wool sucked with a cleaning and protective liquid is applied with a tweezers-like tool to rub and abrade the damaged surface for removing rust, dirt, water, wax and other contaminants. This process effectively combines the benefits of mechanical and chemical cleaning, and is particular suitable for treating a localized small damage on a surface. As the substrate surface is abraded, the protective liquid permeates into small crevices on the substrate surface and also penetrates into the capillary structure of the remaining rust scale, forming a protective layer which prevents surface corrosion and materials degradation. The protective liquid contains solvents and corrosion inhibiting substances such as corrosion inhibitors and is compatible with the touch-up paint that would be applied on the surface.

A further object of the present invention is to provide a means of mixing touch-up paint that matches the color of a damaged organic or metallic coating. A color chart with color recipes, several base paints and simple paint volume measuring tools are used for color matching and mixing. The color chart is pre-prepared using the available base paints.

Another object of the present invention is to provide an effective and inexpensive surface maintenance and coating repair kit that includes apparatus and materials for performing surface preparation, paint mixing and paint application.

Other objectives and advantages of the present invention will become apparent from the following detailed description and accompanying drawings.

### BRIEF DESCRIPTION OF THE DRAWINGS

The accompanying drawings, which are incorporated into and form a part of the disclosure, illustrate a preferred embodiment of the present invention and, together with the description, serve to explain the principles of the present invention.

FIG. 1 illustrates preparation of a representative automobile surface using a tweezers-like tool with abrasive wool sucked with a cleaning and protective liquid.

FIG. 2 illustrates the tweezers-like tool gripping abrasive wool.

FIG. 3 illustrates the removal of excess cleaning and protective liquid from a treated automobile surface using an absorbent towel or sponge.

FIG. 4 illustrates color paint matching using a representative color chart with color recipes.

FIG. 5 illustrates a representative Ostwald's double cone color wheel.

FIG. 6 illustrates a representative color rhombi obtained from dividing the Ostwald's double cone color wheel vertically.

FIG. 7 illustrates color paint mixing using several base paints and simple paint measuring tools.

FIG. 8 illustrates color paint application using a fine brush.

FIG. 9 illustrates a conceptual and representative design of a surface maintenance and repair kit with apparatus for surface preparation, paint mixing and paint application.

### DETAILED DESCRIPTION OF THE INVENTION

This present invention discloses a method and associated apparatus for repairing and protecting material surface and its coatings. More specifically, it discloses a method and apparatus that reduce the level of skill required to perform a quality repair of blemishes, graffiti, coating damages and corrosion on the surfaces of automobiles, boats, aircrafts, machineries, motorbikes, bicycles, washing machines, refrigerators, light fixtures, fence posts, doors, furniture, and other industrial and household appliances and building structures. This is achieved by providing an improved means of surface preparation, an improved means of mixing touch-up paint that matches the color of a damaged surface, and an associated surface maintenance and coating repair kit.

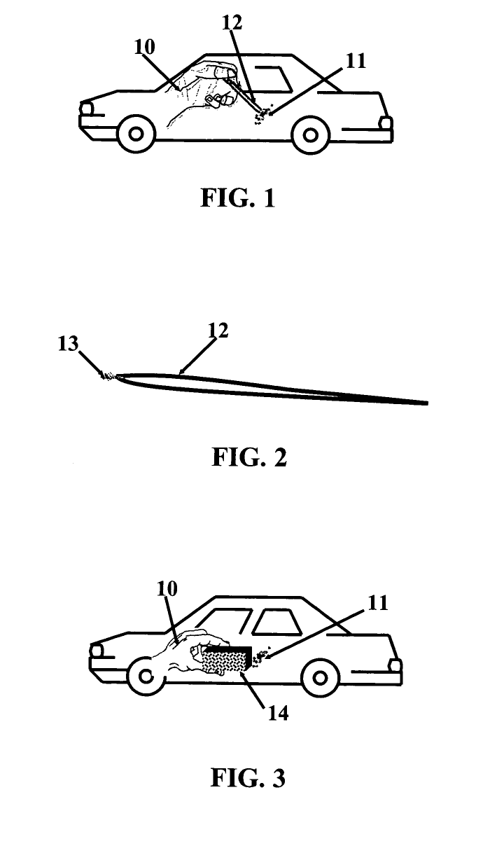

The repair and protection of material surface and its coatings of the present invention begins with the preparation and protection of substrate surface. FIG. 1 illustrates the application of a surface preparation and protection means by hand 10 to treat a locally damaged or rusted surface area 11 on a representative automobile using a tweezers-like tool 12 with abrasive wool. FIG. 2 is an enlargement view of the tweezers-like tool 12 with abrasive wool 13 that has sucked with a cleaning and protective liquid. The damaged or rusted surface area 11 is abraded and rubbed with the abrasive wool 13 using the tweezers-like tool 12. As the substrate surface is abraded, rust, dirt, wax, moisture and other contaminants on the surface are mechanically removed and also chemically displaced. This process effectively combines the benefits of mechanical and chemical cleaning, and is particular suitable for treating a localized small damage on a surface. During the process, corrosion inhibiting substances in the cleaning and protective liquid permeate into crevices on the substrate surface and also penetrate into the capillary structure of the remaining rust scale, forming a preventive layer on the substrate surface.

The wool material is appropriately strong and can be applied using a tweezers-like tool to rub off surface rust and contaminants. Suitable wool materials include cotton, metallic fiber, plastic fiber, glass fiber or their composite. The cleaning and protective liquid contains solvents, rustproofing agent such as corrosion inhibiting substances and binders. Suitable solvents include white spirit, naphtha, isopropanol, xylene or their mixtures. Suitable corrosion inhibiting substances include oil soluble corrosion inhibiting substances such as lanolin, fish oil extractives, metallic soaps of long chain fatty acids, alkali salts of the petrolatum sulphonates and zinc naphthenate. Suitable binders include acrylic resins, epoxy resins, polyurethanes, unsaturated polyester resins, vinyl resins, chlorinated rubbers, oil alkyds, dry or soft film-forming plant or animal oil including resin-hardened wool fat, plasticized bitumen, fish oil, or a solvent-diluted touch-up paint or their mixtures. Tannic and phosphatic acids based rust-converters can also be used as an agent to help removing heavy rust on steel surface although it is not a preferred embodiment of the present invention.

### Example 1

### Preparation of Abrasive Wool Sucked with a Cleaning and Protective Liquid

A steel wool sucked with a cleaning and protective liquid with composition in a manner indicated hereinafter. The wool and the cleaning and protective liquid are mixed until the composition is homogeneously distributed over the surface of the wools.

| | | |
|---|---|---|
| Steel wool | 100 | parts |
| Acrylic resin | 40 | parts |
| Barium salt of the petrolatum sulphonates | 3 | parts |
| Zinc naphthenate | 3 | parts |

The wool and the cleaning and protective liquid can be pre-mixed and packaged for immediate use; the wool and the cleaning and protective liquid can also be mixed just before application. The damaged or rusted surface area 11 is abraded with the abrasive wool 13 sucked with the afore-mentioned cleaning and protective liquid, until a clean and uniformly treated surface is obtained. FIG. 3 illustrates the abraded surface being cleansed and dried using an absorbent towel or sponge 14 to remove any excess cleaning and protective liquid. These processes remove corrosives from the substrate surface and simultaneously protect it by forming a preventive layer. This protective layer can be used alone to protect the substrate surface; it can also be top coated by a touch-up paint as disclosed hereinafter. The cleaning and protective liquid should preferably be compatible to the touch-up paint that is to be applied on the protective layer. In this case, touch-up paint can be applied directly on the preventive layer even before the rustproofing agent has fully dried up. However preferably the preventive layer should be allowed to dry and cure before touch-up paint is applied on it.

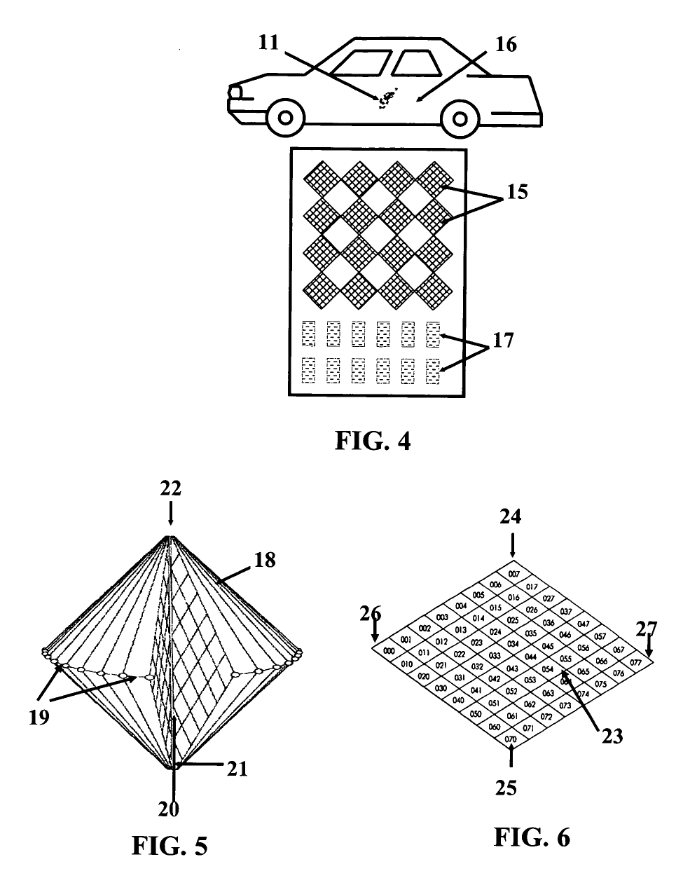

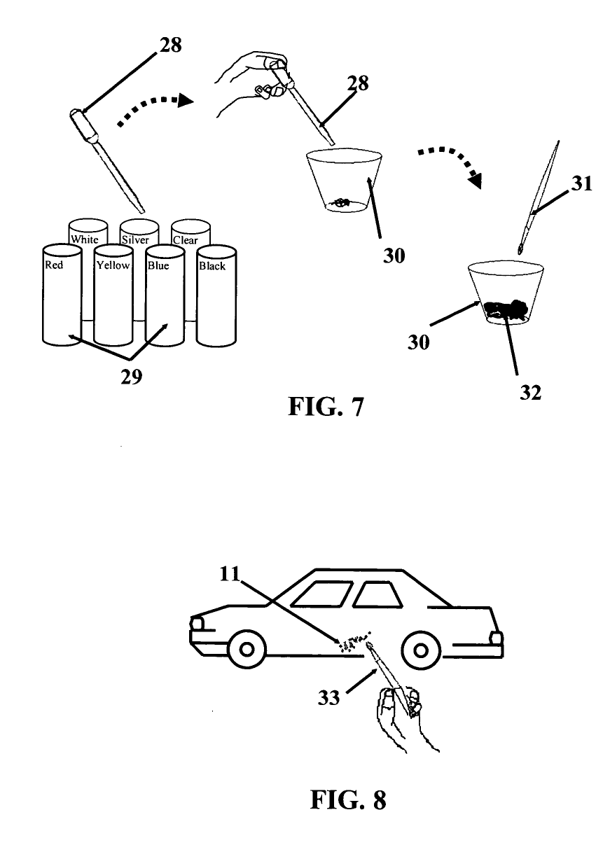

The touch-up paint that is to be applied on the afore-mentioned protective layer is prepared using an improved color matching and mixing method and a small number of available base paints. Mixing a touch-up paint that matches the color of a damaged surface begins with color matching. FIG. 4 illustrates color matching being carried out using a color chart 15, which shows the color of many dried and cured paint films pre-prepared using a small number of available base paints, to directly compare and match the color of a damaged surface 16. Color matching is carried out by holding up the color chart 15 next to a representative automobile surface 16 to visually determine the color of the damaged car surface by direct side by side comparison. The color chart 15 is accompanied with a list of color recipes 17 that shows necessary mixing amounts of standard units of available base color paints in order to prepare a dried color coating shown in the color chart 15. In principle, the color chart 15 can be made by mixing available base color paints in any combinations and proportions and this can give indefinite number of different colors since color mixing theories suggest that mixing three primary colors, red, blue and yellow in different amounts, could make any other colors. In practice, the color chart is usually designed and made based on established color systems such as the double-cone system of Wilhelm Ostwald; Hickethier's Cube; the pyramid model of Johann Heinrich Lambert; the sphere model by Philipp Otto Runge; color wheel of Albert Henry Munsell; and the rhombohedron of Harald Kuppers, see Luigina De Grandis, ‘Theory and Use of Colour’, Blandford Press, 1986.

### Example 2

### Preparation of a Representative Color Chart and a List of Color Recipes Based on the Ostwald's Double-Cone Color System

FIG. 5 illustrates the Ostwald's color system being used to prepare a 680 color chart based on three primary colors plus black and white base paints. The first step of preparing Ostwald's double-cone 18 is the making of a ‘circle of 24 colors’ using available base color paints which usually have three primary colors, red, blue and yellow of any version. Two primaries mixed in equal proportions give a secondary that represents the balance between the two components. Two adjacent colors, one primary and one secondary, mixed in equal proportions give intermediate colors known as “tertiaries”. By mixing a primary with a tertiary in equal proportions, one gets a “quaternary”; by mixing a secondary with a tertiary in equal proportions, one gets a “quinary”. If we introduce these new hues between the various sectors of the color circle, we get a circle of twenty-four colors 19. Two colors in an opposite, complementary position to each other mixed in equal proportions produce a murky color tending toward black and there are twelve pairs of complementaries in the color circle. A double cone 18 can be made by a vertical axis 20 representing the scale of greys from black 21 to white 22 and the circle of twenty-four colors as the equator 19 of the two cones. The equator 19 of Ostwald's double cone color wheel divides it into twenty-four different tonalities. The colors of each tonality gradually intensify as they radiate from the gray center of the axis, finally reaching complete saturation at the periphery, and take on a higher content of white and black as they move vertically in the direction of the respective poles. If the color wheel is divided vertically so that all planes pass through the poles of the axis 20, we get rhombi 23 in FIG. 6. The grey scale, because of its central position, divides each rhombus into two equilateral triangles, the three vertices of which correspond respectively to a full color, to white 24 and to black 25. If, for instance, we place blue-green 26 as a pure color at the tip of the left-hand equilateral triangle, its complementary color, orange-red 27, will appear as a pure color at the tip of the opposite triangle. If, proceeding away from pure colors toward the upper vertex, we gradually add more white; then according to additive principles we get an ordered and graduated progression between full colors and white. Similarly, to obtain an ordered progression of gradations between full color and black, we proceed from the lower tip of the axis, gradually adding more black. On the inside of the triangle are the colors with low saturation, which are characteristically opaque and which we produce by mixing the full color with both white and black. Each vertical section of the Ostwald's double-cone 18 has 56 colors, 28 to each triangle. As a result, the complete solid of 24 triangles contains 672 chromatic colors, plus 8 grades of the gray scale, giving a total of 680. We can also construct color circles with an even greater number of colors, even infinite number of colors if necessary. A list of color recipes 17 can be developed to record the combinations and proportions of available base paints used for painting all colors in Ostwald's double-cone 18. For example, the color 054 shown in rhombi 23 of FIG. 6 could have a composition of red base paint 7 parts; yellow base paint 2 parts; black base paint 1 part. This color recipes list provides the user with a ready reference that can be used to determine the exact colors and exact proportions of the available base paints needed to prepare a color touch-up paint that will produce a dry coating that matches the color of the damaged coating 16. Here the use of the same available base paints to pre-prepare the color chart and also to prepare the touch-up paint is an improvement in the application of color charts for color paint mixing. The use of the same available base paints would ensure that the paints used for preparing the color chart and the paints used for preparing the touch-up are exactly of the same version, and thus ensure high accuracy of color matching and mixing.

The combinations and proportions of base paints in color recipes 17 can be indicated by any volume or weight units. Any tool can be used to measure or weigh the available base paints, for instance, a small measuring glass, a small measuring cylinder and a small injector. However in order to diminish the users' difficulty in accurately measuring a small amount of base color paints for mixing, the preferred embodiment of the present invention measures the base paints by ‘drops’ using a small pipette 28 or a small syringe. The ‘drop’ method enables conducting precise mixing of a small amount of touch-up paint. Base paints 29 are added to a container 30 and are mixed using a small paint brush 31 until all compositions are homogeneously distributed to form a touch-up paint 32. This color matching and mixing can be carried out by unskilled personnel with acceptable precision. This significantly simplifies color matching and mixing.

Suitable base paint materials are the most commonly used primers such as acrylic resins, chemically curing epoxies, polyurethanes, organic zinc-rich primers, unsaturated polyester resins, vinyl resins, chlorinated rubbers, oil alkyds and epoxy esters. Epoxies and polyurethanes give the best chemical resistance, while alkyds and acrylics are often suitable in less aggressive locations. Color coatings containing metallic powers can be used to repair metallic coatings.

The touch-up paint prepared in a manner indicated hereinbefore can be applied using a small paint brush 33 as illustrated in FIG. 8 on any material surface with or without surface preparation. Although the touch-up paint may be applied in any convenient manner, for instance by brush, roller or spraying, in this invention brush is preferred for repairing locally damaged surface. Since conventional touch-up paints are lacquer based and have a low solids/high solvent proportion, the paint shrinks as the solvents evaporate. If the touched up area shrinks lower than the surrounding paint, it may be necessary to apply more than one layer of the touch-up paint. This coating process can be repeated until a satisfactory layer thickness is achieved and the paint is satisfactorily leveled. The coating layer can be further improved by sanding. The sanding is not started until at least a few days after application of the touch-up paint. The area should be constantly flushed with water during sanding. After sanding, the area is rubbed with microfine polish applied with a soft cloth. A good surface repair job can be ended with application of a suitable polish or a clear coat to provide further protection from color fading.

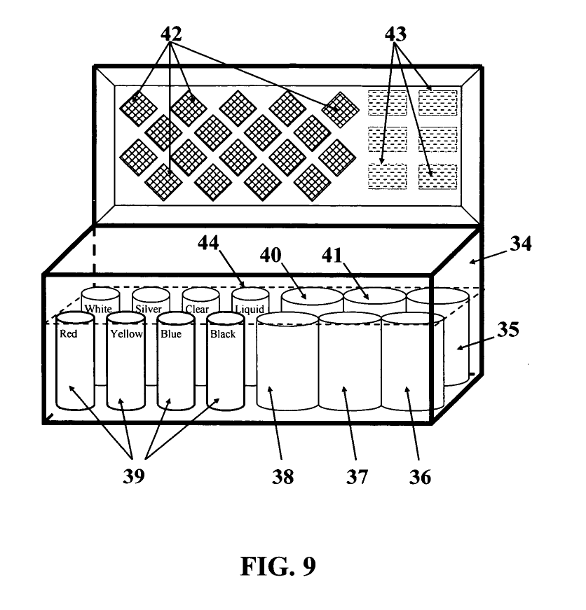

All the materials and tools that are needed for surface coating repair can be included in a surface maintenance and coating repair kit. FIG. 9 illustrates the preferred embodiment of the present invention that a surface maintenance and coating repair kit 34 include a box 35 containing tweezers-like tool, a box containing abrasive wool sucked with a cleaning and protective liquid 36, absorbent towel or sponge 37, small glass or plastic pipettes 38, small number of base paints 39, small empty containers and small brushes for color mixing and application 40, pre-cut sanding papers 41, color chart 42 with color recipes 43. Other components that work complementarily with these items can also be included in the kit, for instance, a rustproofing and lubricating oil 44.

This invention can be used in combination with other protective tool and apparatus such as a protective car cover apparatus that can be used to cover an automobile for protecting the automobile from metal corrosion, paint degradation and interior materials aging due to harmful effects of the environment.

Although the foregoing description of the preferred embodiment of the present invention has shown, described and pointed out the fundamental novel features of the invention, it will be understood that various omissions, substitutions and changes in the form of the detail of the apparatus as illustrated as well as the uses thereof, may be made by those skilled in the art without departing from the spirit of the present invention. Consequently, the scope of the invention should not be limited to the foregoing discussion, but should be defined by the appended claims.

I claim:

1. A method for repairing damaged surface and its coatings comprising the steps of:
rubbing and abrading the damaged surface with a wool sucked with a cleaning and protective liquid using a tweezers-like tool;
removing excess cleaning and protective liquid from the rubbed and abraded surface using an absorbent means;
matching the color of the surface with a pre-prepared color chart with pre-prepared color recipes;
mixing touch-up paint that matches the color of the surface with several base paints, simple volume measuring means and stirrer;
painting the damaged surface with the touch-up paint using a small brush.

2. The method of claim 1, wherein the wool sucked with surface cleaning and protective liquid is fabricated from a cotton wool, metallic fiber wool, plastic fiber wool, glass fiber wool, or composite material wools, wherein the surface cleaning and protective liquid contains solvents and corrosion inhibiting substances such as resin-hardened wool fat, plasticized bitumen and certain metallic soaps, and fish oil, or rust converters of organic in nature and is compatible with the paint to be applied to the surface.

3. The method of claim 1, wherein the absorbent means is a towel or a sponge fabricated from cotton, foam rubber, metal fiber, plastic fiber, glass fiber, or composite materials.

4. The method of claim 1, wherein the pre-prepared color chart is prepared by mixing several available base color paints in any combinations and proportions as indicated in color recipes; wherein the standard amount of the available base paint recorded in the color recipes is indicated by drops.

5. The method of claim 1, wherein the means of mixing touch-up paint is to visually match the color of a damaged surface or a broken coating with a pre-prepared color chart by direct side by side visual comparison.

6. The method of claim 1, wherein the available base paints is a solvent based touch-up paint including chemically curing epoxies, polyurethanes, inorganic and organic zinc-rich primers, water borne acrylics, oil alkyds, epoxy esters, a film forming inhibiting solution; wherein the same version of available base paints are used to pre-prepare the color chart and also to prepare the touch-up paint so as to ensure high accuracy of color matching and mixing.

7. The method of claim 1, wherein the paint volume measuring means is a small pipette or a small injector which can take and measure a standard amount of a base paint shown in the color recipes in terms of a unit of drops so as to conduct precise mixing of a small amount of touch-up paint.

8. A method for surface preparation and protection comprising the steps of:
rubbing and abrading the surface with a wool sucked with a surface cleaning and protective liquid using a tweezers-like tool to rub and abrade the damaged surface for removing rust, dirt, water, wax and other contaminants mechanically and also chemically;
allowing the protective liquid to permeate into small crevices on the substrate surface and penetrate into the capillary structure of remaining rust scale;
removing excess cleaning and protective liquid from the surface using an absorbent means;
forming a protective layer which prevents surface corrosion and materials degradation.

9. A method for color matching and touch-up paint preparation comprising the steps of:
pre-preparing a color chart by mixing several available base color paints in various combinations and proportions;
pre-preparing a list of color recipes which record the necessary mixing amounts of available base color paints in order to prepare dried coatings of chosen colors;
matching the color of the surface with the pre-prepared color chart by direct side by side visual comparison;
mixing touch-up paint by adding the same version base paints according to the combinations and proportions given in the pre-prepared color recipes;
stirring the base paints to produce a homogeneous touch-up paint using a stirrer.

10. A surface maintenance and coating repair kit, comprising:
a wool sucked with surface cleaning and corrosion inhibiting liquid;
a tweezers-like tool for rubbing and abrading the substrate surface;
a pre-prepared color chart;
base color paints;
a coating volume measuring tool;
a touch-up clearcoat or transparent paint compatible with all colors;
a paint applicator having the same size and shape as paper matches;
a fine abrasive sandpaper having grit between 500 to 3000.
